(19) United States
(12) Patent Application Publication
(10) Pub. No.: US 2009/0283457 A1
(43) Pub. Date: Nov. 19, 2009

(54) Waste water management system and method

(75) Inventors: Kevin L. Buchanan, Clarksville, TN (US); Edwin W. Neely, Clarksville, TN (US)

Correspondence Address: Peter K. Johnson;Snell & Wilmer L.L.P., Beneficial Tower, Suite 1200, 15 West South Temple, Salt Lake City, UT, 84101-1547, US

(73) Assignee: ISOS Ventures LLC

(21) Appl. No.: 12/152,534

(22) Filed: May 14, 2008

(51) Int. Cl. B01D 35/143; F04B 49/00; B01D 35/157; B01D 35/26

(52) U.S. Cl. 210/86; 210/109; 210/137; 417/3

(57) ABSTRACT

A system and method for increasing overall efficiency of a waste water system and increasing working efficiency of individual pump stations by implementing an overflow management system. The individual pump station facilitates delaying a discharge of fluid and stores waste water when a down stream pump station has reached a threshold level, thereby delaying or eliminating an overflow situation.

### FIELD OF INVENTION

The present invention relates to managing waste water overflow. More particularly, the present invention relates to a system and method for increasing the overall efficiency of a waste water system and increasing working efficiency of individual pump stations by implementing an overflow management system.

### BACKGROUND OF THE INVENTION

Typical sewage pump stations collect domestic, commercial and industrial sewer flows through a network of gravity sewers. This flow is contained in moderately deep wet wells that are typically designed to include two-hours of emergency storage. Pump stations then typically transport their collected sewage via mechanical pumping into force mains that discharge into adjacent sewer manifolds, interceptors or downstream pump stations. The downstream sewer system often consists of series, parallel, or a combination of both hydraulic piping arrangements to further transport collection system sewer flow to a Water Reclamation Treatment Facility or Wastewater Treatment Plant. As municipal growth occurs, urban sprawl often results, straining existing infrastructure to transport more flow across farther distances away from the treatment facility.

Currently, pumping control for most sewage pump stations is directly related to the pump station's corresponding sewage level in the wet well. Thus, with today's typical infrastructure, each station acts independently of other stations with regard to downstream and upstream pumping capacity resulting in inefficient use of available storage capacity of wet wells and the collection system. Such infrastructure often suffers from sewage overflows from -both equipment failure and hydraulic overloading.

It has been long recognized in the wastewater industry that sewer overflows are not only a violation of the Clean Water Act, but are a potentially costly and litigious problem for any municipality or utility district. Typically, state enforcement of federal regulations often requires that any area or pump station that has five or more overflows in a twelve month period is to be considered a “chronic” overflow point. A chronic overflow point may be considered to have environmentally critical site status. Such condition requires that a moratorium on building shall be established for all areas upstream of the overflow point until such reasons for the overflows are investigated and corrected to eliminate such established overflow condition. Thus, systems and methods that reduce sewage overflows, equipment failure, and/or hydraulic overloading are needed.

### SUMMARY OF THE INVENTION

In accordance with various aspects of the present invention, a waste water pump station includes a wet well, one or more pumps, an influent opening, and an effluent opening. The waste water pump station may further include a pump controller and a communication unit for linking with other pump stations in a waste water management system. Furthermore, the waste water pump station facilitates pumping sewage and runoff water from one location to another location.

Pump controls for upstream and downstream pump stations can be linked together to buffer total system flows and to signal problems with available storage or pumping capacity relative to actual system flows. In an exemplary embodiment, in the event a problem is detected in a downstream pump station such that the influent flow rate exceeds certain parameters relative to its ability to pump the increased flow, the pump “on” condition for upstream pump stations can be successfully delayed as necessary to maximize upstream storage prior to overloading downstream stations and defined system overflow points. Such coordinated management of pump stations directly minimizes the potential for overflows prior to maximizing available system storage. The many station overflows may be avoided and all or nearly all of typical overflows can be minimized through maximizing upstream system storage prior to downstream overflows. In addition, the negative impact of mechanical pump failures on downstream pump stations can be minimized by automated signalization and incorporation of this pump failure condition into any Supervisory Control And Data Acquisition (SCADA) system while simultaneously maximizing upstream storage in the collection system and station wet well.

### BRIEF DESCRIPTION OF THE DRAWINGS

A more complete understanding of the present invention may be derived by referring to the detailed description and claims when considered in connection with the Figures, where like reference numbers refer to similar elements throughout the Figures, and:

FIG. 1 illustrates a block diagram of an exemplary pump station;

FIG. 2 illustrates another block diagram of an exemplary pump station with an auxiliary storage;

FIG. 3 illustrates a layout of an exemplary waste water management system configured to reduce waste water overflow occurrences in accordance with an exemplary embodiment;

FIG. 4 illustrates a layout of an exemplary waste water management system configured to increase working efficiency of individual pump stations in accordance with an exemplary embodiment;

FIG. 5 illustrates a flowchart of an exemplary method at a pump station of a waste water management system; and

FIG. 6 illustrates a flowchart of another exemplary method at a pump station of a waste water management system.

### DETAILED DESCRIPTION OF EXEMPLARY EMBODIMENTS OF THE INVENTION

The present invention may be described herein in terms of various functional components and various processing steps. It should be appreciated that such functional components may be realized by any number of hardware, software, or structural components configured to perform the specified functions.

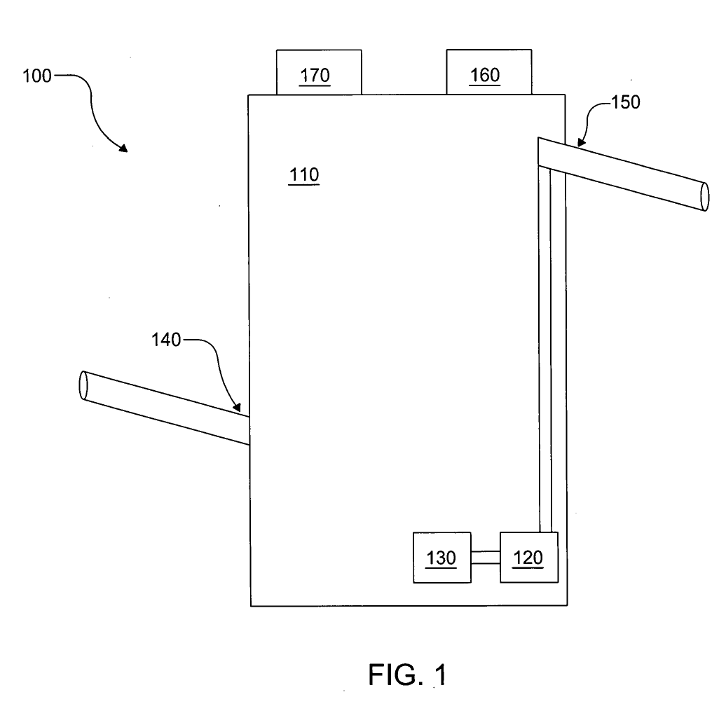

In accordance with various aspects of the present invention, and with reference to FIG. 1, a waste water pump station 100 includes a wet well 110, a first pump 120, a second pump 130, an influent opening 140, and an effluent opening 150. In another exemplary embodiment, waste water pump station 100 may further include a pump controller 160 and a communication unit 170. In one embodiment, waste water pump station 100 facilitates pumping fluid from one location to another location. Typically the fluid may include sewage and runoff water.

In an exemplary embodiment, first pump 110 is a single speed pump. In another embodiment, first pump 110 is a variable speed pump. Additionally, second pump 120 may be of the same pump type as first pump 110, or second pump may be a different pump type than first pump 110. Moreover, first pump 110 and second pump 120 may be any suitable pump for use in a waste water pump station as would be known to one skilled in the art.

Furthermore, in an exemplary embodiment, pump controller 160 sets the operating points for waste water pump station 100, controlling when first pump 110 and second pump 120 are turned “on”, active, “off”, inactive, and/or otherwise controlling the operation of station 100. In one embodiment, pump controller 160 receives data from communication unit 170 and applies the data in order to determine the operating points. In another embodiment, pump controller 160 receives operating point values and resets and/or adjusts the operating points to correspond with the operating point values. Pump controller 160 may be any suitable controller which is capable of changing and/or controlling the operating points of waste water pump station 100. More generally, pump controller 160 may include any pump controller configured to control pump(s) 120, 130 based on data that is not about that particular waste water pump station 100, whether such data comes from other pump stations or a data center.

In an exemplary embodiment, communication unit 170 receives data from an outside source, such as another communication unit from another pump station. Communication unit 170 is also in communication with pump controller 160 to send and/or receive data to and/or from controller 160. Communication unit 170 may include a line-of-sight radio, an infrared connection, a wireless connection, or a wired connection. Moreover, communication unit 170 may use any suitable method of communication as would be known to one skilled in the art. Data communicated may include data about one or more pump stations, systems loads, and/or other system information.

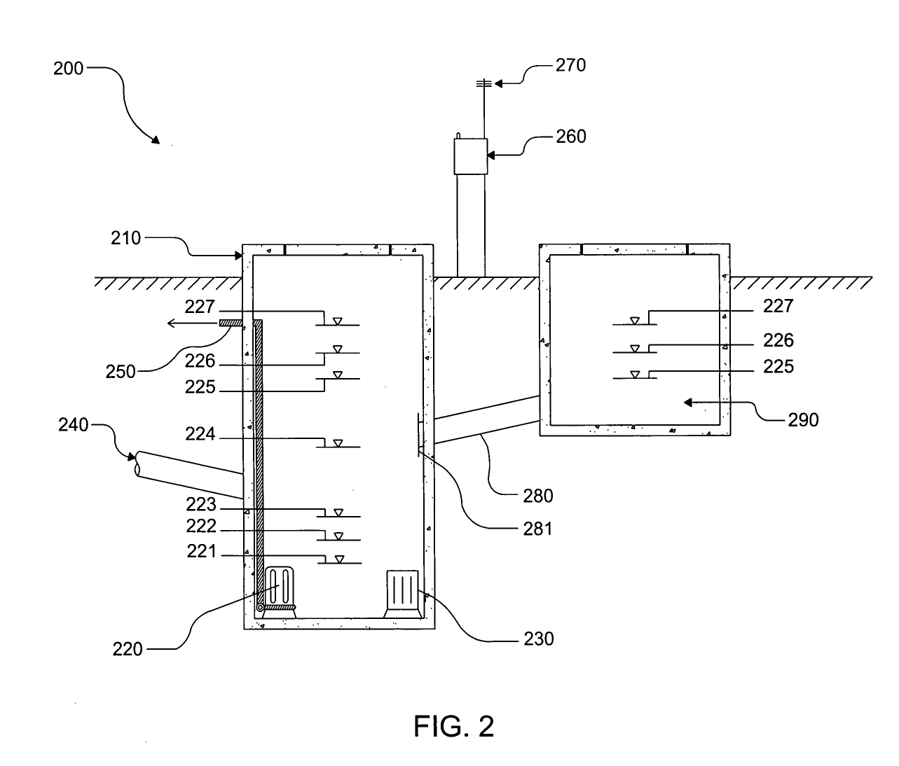

In an exemplary embodiment, and with reference to FIG. 2, a waste water pump station 200 includes a wet well 210, a first pump 220, a second pump 230, an influent opening 240 in wet well 210, and an effluent opening 250 out of wet well 210. In addition, an exemplary embodiment waste water pump station 200 may include at least one pump station sensor (not shown), a pump controller 260 and a communication unit 270.

Furthermore, in another exemplary embodiment, waste water pump station 200 may include a cross-over piping 280 connected between wet well 210 and an auxiliary storage tank 290. In one embodiment, a porous covering 281 filters the opening of cross-over piping 280. In an exemplary embodiment, porous covering 281 may include a screen, a membrane, or any other suitable material. Porous covering 281 minimizes maintenance of auxiliary storage tank 290 and facilitates drainage back into wet well 210 after use for emergency storage. Auxiliary storage tank 290 provides additional waste water storage capacity. Such additional capacity may be necessary due to system limitations.

The pump station sensor is configured to sense the status of waste water pump station 200. The status may include a variety of pump station data, including fluid level, flow rate, pressure, volume, power, the status of the pumps, a signal by a manual operator, and any other pump station data as would be known to one skilled in the art. In an exemplary embodiment, various wet well levels in both wet well 210 and auxiliary storage tank 290 may be detected by pump station sensor, which correspond to actions such as, for example, pump on 222, pump off 221, lag on 223, lag off 221, emergency pump on 225, emergency pump off 224, emergency lag on 226, emergency lag off 224, and high alarm 227. These pump levels may be adjusted by pump controller 260.

In an exemplary embodiment, the “pump on” action 222 activates first pump 220 and the “pump off” action 221 turns off first pump 220. In an exemplary embodiment, the “lag on” action 223 activates second pump 230 and the “lag off” action 221 turns off second pump 230. In another exemplary embodiment, the “emergency pump on” action 225 activates first pump 220 and second pump 230 as priority over the status of other pump stations in the waste water system and the “emergency pump off” action 224 removes the priority status of activating first pump 220 and second pump 230.

The priority status of one pump over another may be determined by any pump controller or other logic device, for example the pump control 260, and in turn communicated to the pump controller 260 through the communication unit 270. The communication unit 270 may in turn communicate the priority status to other units. For example, units upstream the influent opening 240, may receive communication from a downstream communication unit 270 that pump controller 260 has determined that pump station 200 is has reach emergency status and thus should take higher priority over the upstream pump station. In an exemplary embodiment, a high alarm 227 signals that waste water pump station 200 may imminently overflow.

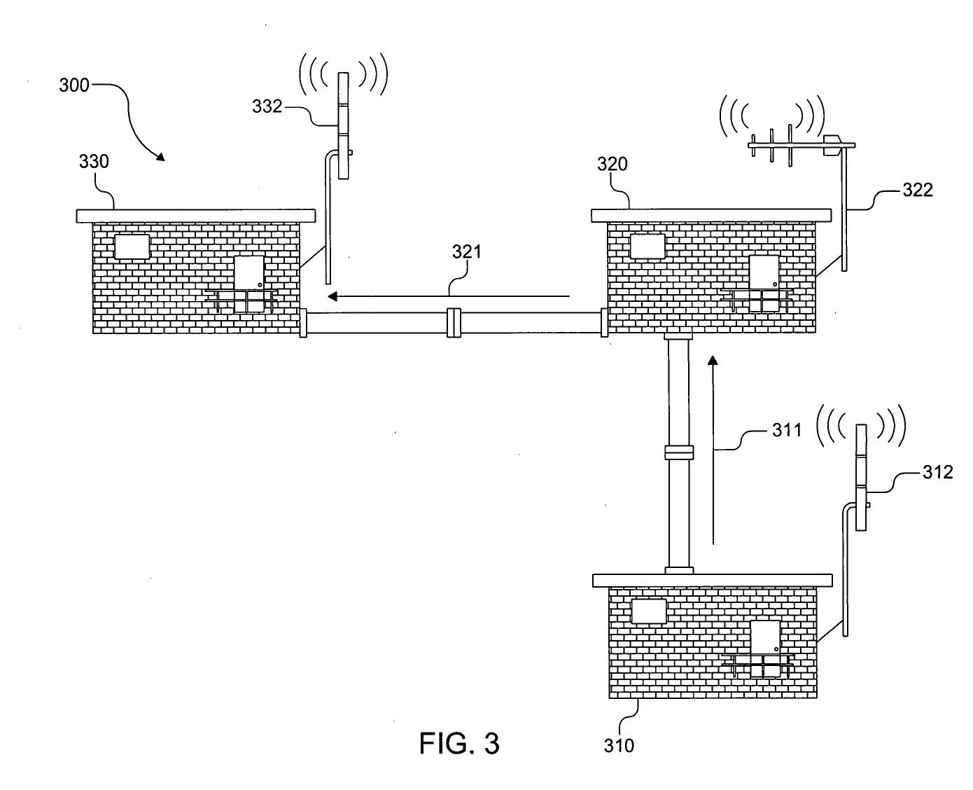

In accordance with an exemplary embodiment, a pump station is part of a waste water management system connected in a serial configuration. For purposes of illustration, and with reference to FIG. 3, a serial configuration of pump stations includes a first pump station 310, a second pump station 320, and a third pump station 330. In an exemplary embodiment, pump stations 310, 320, 330 are similar to waste water pump stations 100, 200. The fluid in the waste water management system flows from upstream locations to downstream locations. In an exemplary embodiment, first pump station 310 is upstream of second pump station 320 and third pump station 330, and third pump station 330 is down stream of first pump station 310 and second pump station 320. Fluid flows in a direction 311 from pump station 310 to pump station 320 and in a direction 321 from pump station 320 to pump station 330.

Typically, a pump station system includes pump stations which operate independently of each other or in coordination with each other by means of a central communications and control system. However, in accordance with an exemplary embodiment, second pump station 320 communicates directly with other pump stations via communication units 312, 322, 332 in the same waste water management system without the need to install and operate an expensive central communications and control system.

In an exemplary embodiment, when second pump station 320 receives communication, from any source, for example, from communication unit 332, that the threshold level was reached by downstream third pump station 330, second pump station 320 adjusts its own various levels such that fluid pumped towards pump station 330 is decreased (e.g., by shutting one or more pumps off, by cycling off and on at an intermittent rate, and/or by pumping at a slower rate) thereby storing the fluid so that third pump station 330 may have a decreased influent flow rate. This may occur, for example, by increasing the height of the “pump on” level and/or the “lag on” level of second pump station 320 and/or by ignoring the “pump on” and/or “lag on” levels such that the pumps of pump station 320 are not turned on until higher emergency threshold levels are met in pump station 320. In one embodiment, second pump station 320 does not turn on the pump and/or lag pump until third pump station 330 has returned to normal operation.

Furthermore, in another exemplary embodiment, second pump station 320 adjusts operations based on data of both upstream first pump station 310 and downstream third pump station 330. In relation to upstream data, second pump station 320 may adjust operations based on anticipated influent flow rate or levels. Furthermore, in an exemplary embodiment, second pump station 320 may receive data from any pump station in the waste water management system.

In accordance with an exemplary embodiment, the elements of the present systems and methods of the invention can be directly incorporated into typical existing pump station controls and any available SCADA systems. Furthermore, in an exemplary embodiment and in the event no SCADA system is available, the present systems may include a built-in line-of-sight radio, an internet and Ethernet communication capability, and/or a wireless communication capability. Moreover, the present systems may include any suitable communication protocol for communication between other pump stations and station monitoring systems as would be known to one skilled in the art.

While using radio systems may require the addition of some new repeaters and antennas, in one embodiment it may be possible to utilize existing radio equipment. In an exemplary embodiment, each pump station is specifically designed to take advantage of the available collection system and wet well storage capacities through intelligent control of pumping capability resulting in strategic sewer system flow management.

One skilled in the art would recognize that the concepts described above in relation to a serial configuration of pump stations are equally applicable to other pump station configurations. For example, the waste water management system may use parallel configurations or any combination of serial and parallel connections.

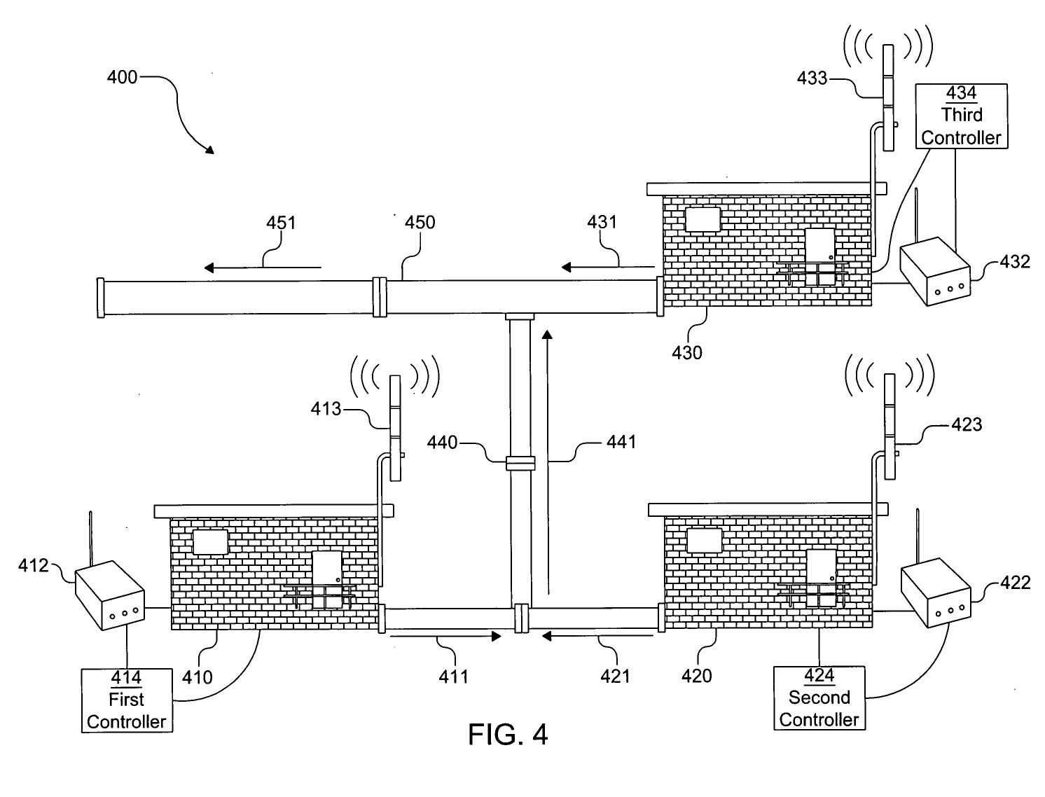

In accordance with an exemplary embodiment, and with reference to FIG. 4, a pump station is part of a waste water management system connected in a parallel configuration. In an exemplary embodiment, a waste water management system 400 includes a first pump station 410, a second pump station 420, a third pump station 430, a first force main 440 into which both first pump station 410 and second pump station 420 discharge fluid in directions 411, 421, and a second force main 450 into which both third pump station 430 and first force main 440 discharge fluid. Second force main 450 directs fluid in a direction 451. In another exemplary embodiment, waste water management system 400 further includes a first communication unit 412 and/or 413 at first pump station 410, a second communication unit 422 and/or 423 at second pump station 420, and a third communication unit 432 and/or 433 at third pump station 430. In yet another exemplary embodiment, waste water management system 400 further includes a first controller 414 at first pump station 410, a second controller 424 at second pump station 420, and a third controller 434 at third pump station 430.

Furthermore, in an exemplary embodiment, the efficiency of a pump station is increased if not pumping simultaneously as another parallel pump station. When a pump station is actively pumping fluid, it increases the pressure in a force main. Therefore, if another parallel pump station is also active, both pump stations have an increased work load in comparison to being active separately. In an exemplary embodiment, the pump stations 410, 420, 430 of waste water management system 400 operate efficiently by pumping at different intervals depending upon operation of the other pump stations, pressure in the main lines, and/or other measurable factors.

In another exemplary embodiment, waste water management system 400 operates efficiently by pump stations 410, 420, 430 communicating with each other the current mode of operation, for example whether the pump is active or not active. For example, in one embodiment, second pump station 420 determines whether to actively pump based in part of the status of first pump station 410 and/or third pump station 430. In an exemplary embodiment, when the fluid level reaches a “pump on” level at second pump station 420, second controller 424 is configured to delay active pumping if another pump station, such as a parallel pump station or an immediate downstream pump station, is already pumping. Furthermore, second controller 424 is configured to initiate active pumping if an “emergency on” level of fluid is reached regardless of the status of other pump stations.

The benefits of configuring a pump station to selectively pump based on the status of other pump stations includes, for example, reduced pressure in a force main, shorter pump run times and corresponding increased expected pump life, and more predictable pumping resulting in a buffered peak flow to downstream facilities.

In one embodiment, a communication unit continuously broadcasts the status of the corresponding pump station. In another embodiment, a communication unit broadcasts the status of the corresponding pump station when the status changes. In yet another embodiment, a communication unit broadcasts the status of the corresponding pump station at a certain interval, such as, for example, every five minutes. In another embodiment, a communication unit continuously receives data such as the status of another broadcasting pump station. In another embodiment, a communication unit receives the status of another broadcasting pump station when the status of the other pump station changes, such as by being pinged by the other pump station's broadcasting communication unit. In yet another embodiment, a communication unit receives the status of another broadcasting pump station at a certain interval, such as, for example, every five minutes.

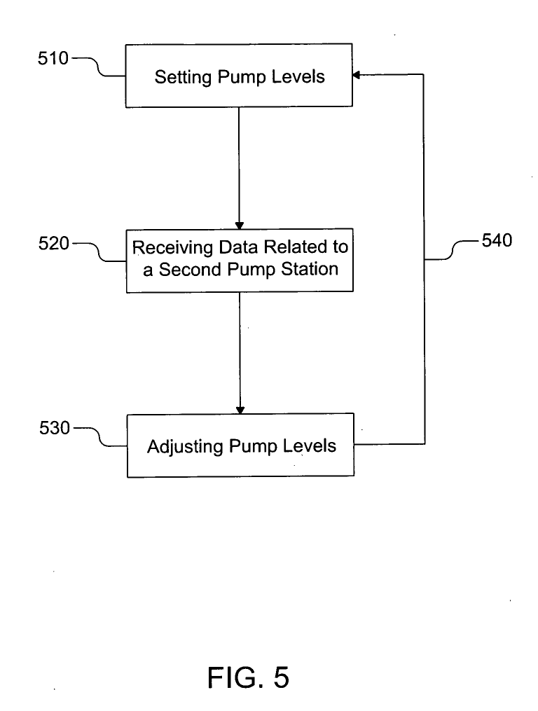

Various methods may be employed to practice the invention herein described. One exemplary method of pump station interaction, with reference to FIG. 5, includes setting pump levels (Step 510), receiving data related to a second pump station (Step 520), and/or adjusting the pump levels (Step 530). The exemplary method may further include resetting or adjusting the pump levels (Step 540) to the default levels of Step 510. Variable and/or constant speed pumps may be used in any number an/or combination.

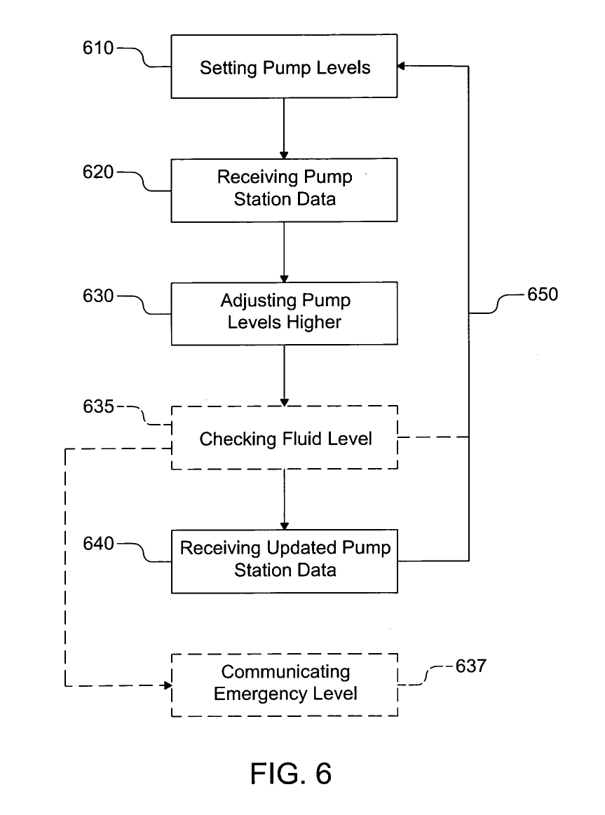

One situation occurs when a downstream pump station has rising fluid levels and may overflow. Another exemplary method at an upstream pump station, and with reference to FIG. 6, includes setting pump levels (Step 610), receiving data indicating a downstream pump station has reached a threshold level (Step 620), increasing the water level in the well of an upstream pump station to at least one of the “pump on” and “lag on” levels (Step 630), and/or receiving updated data (Step 640) indicating the downstream pump station has reached a level sufficiently below the threshold level. The threshold level may be any level which necessitates action by a pump station outside of normal operation. For example, a threshold level may be reached when a fluid level reaches “emergency pump on” level. In one embodiment, threshold level may be reached when a fluid level reaches “lag on” level. A threshold level may also be automatically determined and/or reached upon the occurrence of any other condition or upon manual override by an operator of the system. An exemplary method may also include resetting and/or adjusting the pump levels (Step 650) to those of Step 610. Furthermore, the exemplary method may further include repeatedly checking the upstream pump station's own fluid level (Step 635) and resetting the pump levels (Step 650) if an emergency level is reached. Furthermore, the exemplary method may further include communicating (Step 637) the status or fluid level of the current pump station to one or more upstream and/or downstream stations.

The present invention has been described above with reference to various exemplary embodiments. However, those skilled in the art will recognize that changes and modifications may be made to the exemplary embodiments without departing from the scope of the present invention. For example, the various exemplary embodiments can be implemented with other types of waste water pump stations and waste water management systems and methods in addition to those illustrated above. These alternatives can be suitably selected depending upon the particular application or in consideration of any number of factors associated with the operation of the system. Moreover, these and other changes or modifications are intended to be included within the scope of the present invention, as expressed in the following claims.

1. A method of adjusting pump level control, the method comprising:
setting pump levels of a first pump station;
receiving data related to a second pump station directly from the second pump station; and
adjusting the pump levels of the first pump station based on the data in order to optimize an overall pump station system.

2. The method of claim 1, wherein adjusting of the pump levels further includes optimizing the overall pump station by preventing overflows by storing fluid upstream and increasing the pump level heights if the data indicates the level of the second pump station is high.

3. The method of claim 1, wherein the data may comprise at least one of a fluid level of the second pump station, an emergency level indicator, and an adjusted level value.

4. The method of claim 1, further comprising resetting the pump levels to a default setting.

5. The method of claim 4, wherein the order of resetting the pump levels in the overall pump station system is determined by at least one of whether a pump station is closer to overflow than another pump station in the overall pump station system, a pumping ability of a pump station in the overall pump station system, and an environmentally critical site status of a pump station in the overall pump station system.

6. The method of claim 1, further comprising receiving a manual signal to delay pumping.

7. The method of claim 1, further comprising receiving data related to a third pump station, wherein the third pump station is connected upstream of the first pump station, and wherein the second pump station is connected downstream of the first pump station.

8. The method of claim 1, wherein the second pump station is immediately connected to the first pump station.

9. The method of claim 8, wherein the second pump station and first pump stations pump into a common force main fluid line.

10. The method of claim 1, wherein the second pump station may be any pump station in the overall pump station system.

11. A waste water management system comprising:
a first pump station comprising a wet well, a first pump, a second pump, an influent opening, an effluent opening, a pump station controller, and a communication unit; and
a second pump station in connection with the first pump station;
wherein the first pump station pump operation levels are determined in part on the status of the second pump station.

12. A first pump station configured to facilitate localized control of operation settings in the first pump station, the first pump station comprising:
a wet well;
a first pump and a second pump configured to pump fluid from the wet well to a second pump station;
a communication unit configured to facilitate communication with the second pump station; and
a pump station controller configured to control pump level settings;
wherein the pump station controller controls the pump level settings based in part on data received from the second pump station.

13. The waste water management system of claim 13, wherein the first pump station further comprises an auxiliary storage tank.

14. A waste water management system comprising:
a first pump station comprising a pump active level, a pump threshold level, and a first communication unit;
a second pump station including a second communication unit; and
a force main into which the first pump station and the second pump station each discharge fluid;
wherein the first pump station is configured to discharge fluid into the force main upon reaching the pump active level when the second pump station is not discharging.

15. The waste water management system of claim 14, wherein the first pump station is configured to discharge fluid into the force main upon reaching the pump threshold level even when the second pump station is discharging.

16. The waste water management system of claim 14, wherein the first communication unit receives data from the second communication unit, and wherein the data indicates the status of the second pump station.

17. The waste water management system of claim 16, wherein the second communication unit continuously transmits the data.

18. The waste water management system of claim 16, wherein the second communication unit transmits the data upon a change in status of the second pump station.

19. The waste water management system of claim 16, wherein the second communication unit transmits the data at a periodic interval.

20. The waste water management system of claim 16, wherein the first communication unit receives data from the second communication unit by at least one of the following processes: continuously, intermittently, and upon a change of status in the second pump station.

21. A first pump station configured to facilitate localized control of operation settings, the first pump station comprising:
a wet well;
a first pump configured to pump fluid out of the wet well;
a communication unit configured to facilitate receiving external information, wherein said external information is information that is relevant to the status of portions of a system of which said first pump station is a part, but wherein said external information is not information relevant to the status of said first pump station; and
a pump station controller configured to control pump level settings;
wherein the pump station controller controls the pump level settings based in part on said external information.
